(19) United States
(12) Patent Application Publication
(10) Pub. No.: US 2023/0010993 A1
(43) Pub. Date: Jan. 12, 2023

(54) CARBON DIOXIDE EXTRACTION ELECTROLYSIS REACTOR

(71) Applicant: Dioxycle, Bordeaux (FR)

(72) Inventors: David Wakerley, Bordeaux (FR); Sarah Lamaison, Bordeaux (FR)

(73) Assignee: Dioxycle, Bordeaux (FR)

(21) Appl. No.: 17/471,593

(22) Filed: Sep. 10, 2021

Related U.S. Application Data
(60) Provisional application No. 63/220,572, filed on Jul. 12, 2021.

(51) Int. Cl. C25B 9/17; C25B 1/00; C25B 3/23; C25B 3/07; C25B 15/08

(52) U.S. Cl. CPC C25B 9/17; C25B 1/00; C25B 3/23; C25B 3/07; C25B 15/08

(57) ABSTRACT

Methods and systems related to the field of carbon capture and utilization are disclosed. Disclosed electrolysis reactors can have a cathode area having a cathode output and a cathode input for an input fluid and an anode area having an anode input and an anode output. The carbon input fluid contains carbon dioxide. The cathode area reduces an oxygen-containing species into hydroxide ions and reacts them with the carbon dioxide to form anions containing carbon. The anode area oxidizes one or more oxidizable species to generate a protonating species. The electrolysis reactors can have a third output for a carbon output fluid. The electrolysis reactors can begin to produce carbon dioxide from the anions containing carbon and the protonating species in response to a potential of less than 1.23 V applied across the cathode terminal and the anode terminal.

### CROSS REFERENCE TO RELATED APPLICATION

This application claims the benefit of U.S. Provisional Patent Application No. 63/220,572, filed on Jul. 12, 2021, which is incorporated by reference herein in its entirety for all purposes.

### BACKGROUND

Carbon dioxide (CO₂) accumulation in the atmosphere is a major culprit in global warming. Capturing it using a decarbonized source of electricity at emitting sources or directly from the air (through direct air capture) and converting it into valuable chemicals and fuels is a promising way to both reduce its atmospheric concentration and offer sustainable alternatives to current fossil-fuel-derived feedstocks. Among the envisioned conversion technologies, polymer-electrolyte-membrane-based electroreduction technology stands out by its versatility (possible use at a wide range of temperatures and pressures) and amenability to generate a wide range of products.

### SUMMARY

Methods and systems related to the field of carbon capture and utilization are disclosed. The methods and systems described in this disclosure can be environmentally beneficial for the conversion of carbon accumulated in the atmosphere, or destined for disposal into the atmosphere, by electrochemical reduction into other chemicals, such as valuable and sustainable chemicals or fuels.

In specific embodiments of the invention, an electrolysis reactor is provided. The electrolysis reactor comprises a cathode area having a cathode output, and a cathode input for an input fluid. The input fluid contains carbon dioxide. The cathode area is configured to (i) reduce an oxygen-containing species into hydroxide ions in a reduction reaction; and (ii) react the hydroxide ions with the carbon dioxide from the input fluid to form anions containing carbon. The electrolysis reactor also comprises an anode area. The anode area oxidizes one or more oxidizable species in an oxidation reaction to generate a protonating species. The electrolysis reactor also comprises a cathode terminal and an anode terminal. The electrolysis reactor begins to produce carbon dioxide from the anions containing carbon and the protonating species in response to a potential of less than 1.23 V applied across the cathode terminal and the anode terminal.

In specific embodiments of the invention, an electrolysis reactor is provided. The electrolysis reactor comprises a cathode area having a cathode output, and a cathode input for an input fluid. The input fluid contains carbon dioxide and an oxygen-containing species. The cathode area (i) reduces an oxygen-containing species from the input fluid into hydroxide ions; and (ii) reacts the hydroxide ions with the carbon dioxide from the input fluid to form anions containing carbon. The electrolysis reactor also comprises an anode area having an anode input and an anode output. The anode area oxidizes one or more oxidizable species to generate a protonating species. The electrolysis reactor also comprises a third output for a carbon output fluid. The carbon output fluid contains carbon dioxide generated from the anions containing carbon and the protonating species. The third output is separate from the anode output and the cathode output.

In specific embodiments of the invention, a method is provided. The method comprises receiving, at a cathode area of an electrolysis reactor, an input fluid containing carbon dioxide. The cathode area comprises a cathode input for the carbon input fluid and a cathode output. The method also comprises reducing, via a reduction reaction at the cathode area, an oxygen-containing species into hydroxide ions. The method also comprises reacting, at the cathode area, the hydroxide ions with the carbon dioxide from the input fluid to form anions containing carbon. The method also comprises oxidizing, via an oxidation reaction at an anode area of the electrolysis reactor having an anode input and an anode output, one or more oxidizable species to generate a protonating species. The method also comprises providing, at a third output, a carbon output fluid. The carbon output fluid contains carbon dioxide generated from the anions containing carbon and the protonating species. The third output is separate from the anode output and the cathode output.

### BRIEF DESCRIPTION OF THE DRAWINGS

FIG. 1 includes an example of a reactor, in accordance with specific embodiments of the invention disclosed herein.

FIG. 2 includes graphs illustrating the energy requirements for specific redox reactions, in accordance with specific embodiments of the invention disclosed herein.

FIG. 3 includes a flowchart for a set of methods for an electrolysis reactor, in accordance with specific embodiments of the invention disclosed herein.

FIG. 4 includes an example of a reactor capable of performing the method of FIG. 3, in accordance with specific embodiments of the invention disclosed herein.

FIG. 5 includes an example of a reactor that includes an anion-exchange membrane, a cation-exchange membrane, and a separating area, in accordance with specific embodiments of the invention disclosed herein.

FIG. 6 includes an example of a reactor used to separate CO₂ from a mixture of N₂ and O₂ through the reduction of O₂, in accordance with specific embodiments of the invention disclosed herein.

FIG. 7 includes an example of a reactor where CO₂ is removed from a gas stream through the reduction of O₂ at the cathode and the oxidation of hydrogen (H₂) at the anode, in accordance with specific embodiments of the invention disclosed herein.

FIG. 8 includes an example of a reactor where CO₂ is removed from a gas stream using water electrolysis, in accordance with specific embodiments of the invention disclosed herein.

FIG. 9 illustrates an example of a reactor where the cathode output circulates to the anode input, in accordance with specific embodiments of the invention disclosed herein.

FIG. 10 includes non-exhaustive examples of potential valuable oxidations, in accordance with specific embodiments of the invention disclosed herein.

### DETAILED DESCRIPTION

Devices and methods related to the field of electrolysis reactors and CO₂ capture in accordance with the summary above are disclosed in detail herein. The devices and methods disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Specific embodiments of the invention involve reactors which utilize oxidation-reduction reactions to remove carbon from a carbon input fluid. The carbon input fluid can be a liquid containing carbon (such as carbonized wastewater) or a gas containing carbon (such as atmospheric air containing CO₂ or a direct source of carbon emission). The reactors in accordance with specific embodiments of the present invention can include a cathode area, where a reduction reaction can take place, and an anode area, where an oxidation reaction can take place. The carbon input fluid can be provided to the cathode area. In specific embodiments of the invention, the general electrochemical theory of the reactor will be in accordance with the following description.

In specific embodiments of the invention, a device is provided. The device can be an electrolysis reactor (e.g., an electrolysis cell or a set of electrolysis cells). The electrolysis reactor can comprise a cathode area and an anode area. The cathode area can have a cathode input and a cathode output and can undertake a reduction reaction. The anode area can have an anode input and an anode output and can undertake an oxidation reaction. In the cathode area, a reduction reaction can be undertaken that produces hydroxide ions (e.g., OH⁻). The hydroxide ions can react with the carbon dioxide (CO₂) to produce anions containing carbon, such as but not limited to carbonate (CO₃²⁻) or bicarbonate (HCO₃⁻).

Non-limiting examples of the reactions that can take place in the cathode area are illustrated below as Reactions 1-3:

A+ne⁻→B+nOH⁻ (1)

CO₂+OH⁻→HCO₃⁻ (2)

HCO₃⁻+OH⁻→CO₃²⁻+H₂O (3)

Reduction reactions commonly consume protons from water to generate hydroxide. Therefore, a source of water (e.g., water directly provided at the cathode input, a humidifier for humidifying the fluid at the cathode input, etc.) can be provided at the cathode in order to facilitate the generation of the hydroxide. In specific embodiments of the invention, the hydroxide from the reduction reaction (such as Reaction 1 above) can be generally seen as a by-product rather than the product of interest of the electrochemical process. The hydroxide by-product can efficiently react with CO₂ to form anions containing carbon such as bicarbonate (Reaction 2 above) and/or carbonate (Reaction 3 above), but does not react with non-acidic gases, such as carbon monoxide, ethylene, methane, nitrogen and oxygen. In specific embodiments of the invention, this allows separation of CO₂ from many common gases.

The anions containing carbon (e.g., either carbonate obtained via Reaction 3, bicarbonate obtained via Reaction 3, or both) can travel across the reactor, from the cathode towards the anode, using various approaches disclosed herein. The anions containing carbon can interact with a portion of the reactor that protonates (i.e., gives a proton (H⁺) to) the anions containing carbon to form CO₂.

After reacting with the hydroxide ions as illustrated in Reactions 1-3, the negatively charged anions containing carbon formed from CO₂ can flow from the cathode area towards the anode area, which can be protonated in the more acidic environment. This process can generate CO₂ and water, for example through Reactions 4 and 5 below. In specific embodiments of the invention, CO₂ is advantageously the sole gaseous product of this reaction and can be easily separated from the generated water.

Examples of the reactions that can take place to protonate the anions containing carbon are illustrated below in Reactions 4-5, for the specific examples of carbonate (CO₃²⁻) and bicarbonate (HCO₃⁻).

HCO₃⁻+H⁺→CO₂+H₂O (4)

CO₃²⁻+2H^{+→CO}₂+H₂O (5)

Regeneration of protons can occur in a separating area between the anode and the cathode, or through oxidation reactions that occur at the anode. An example of an oxidation reaction occurring at the anode to generate the protons required for the protonation is illustrated in Reaction 6 below, and can include, but it is not limited to water oxidation, hydrogen oxidation, partial oxidation of hydrocarbons or alcohols, etc.

B→A+mH⁺+ne⁻ (6)

The voltage required to separate the CO₂ can be determined by the difference in potential between the anode and cathode reactions, the catalytic overpotentials for said reactions, the pH gradient between the anode and cathode and the resistance of the device. The power requirement can be determined by the rate of CO₂ separation (current) multiplied by the voltage.

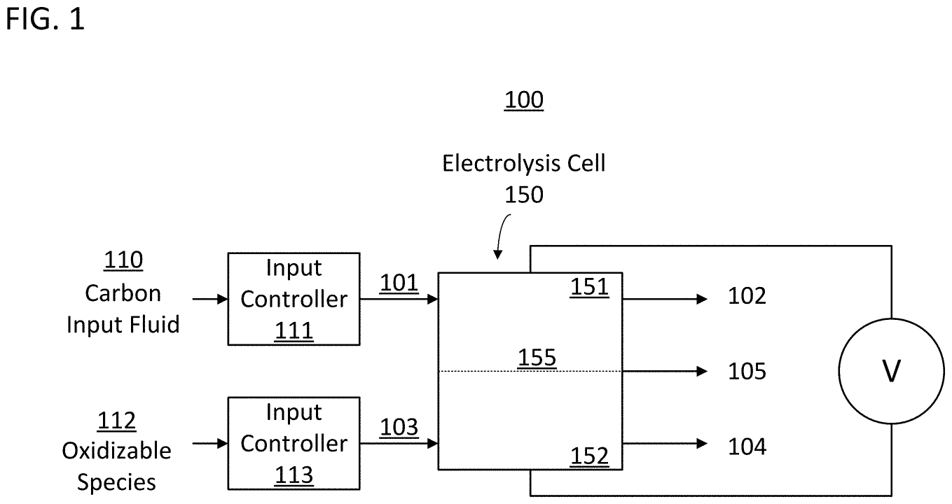

FIG. 1 includes an example of a reactor 100 in accordance with specific embodiments of the invention. The reactor 100 includes at least one electrolysis cell 150. The cell 150 includes a cathode input 101 for receiving an input fluid, such as a carbon input fluid 110. The carbon input fluid can contain CO₂ and other species, such as an oxygen-containing species. The cathode input 101 can be optionally connected to an input controller 111 for controlling the incoming flow of carbon input fluid 110. The cell 150 further includes an anode input 103 for receiving an input fluid, such as an oxidizable species 112. The anode input 103 can be optionally connected to an input controller 113 for controlling the incoming flow of oxidizable species 112. Cell 150 additionally includes a cathode output 102 and an anode output 104 for the respective outputs of the reactions undertaken at the reactor.

The electrolysis cell can include a cathode area, such as cathode area 151. The cathode area can comprise a cathodic catalyst layer able to reduce a substance to generate hydroxide as a product or a by-product. The in-situ generation of OH⁻ adjacent to the cathode exposed to the CO₂ can facilitate the reaction of hydroxide with carbon dioxide which propagates the separation process. The cathode can further comprise a catalyst layer on a gas diffusion layer, which can encourage the diffusion of the gas from a stream to the surface of the catalyst, as well as allowing the release of non-reacted/product gases. In this way, the cathode area can reduce the oxygen-containing species from the carbon input fluid 110 into hydroxide ions and reacts the hydroxide ions with the CO₂ from the carbon input fluid 110 to form anions containing carbon.

The electrolysis cell can include an anode area, such as anode area 152. The anode area can comprise an anodic catalyst layer able to oxidize a substance to produce a product and/or protons. The anodic catalyst may be deposited onto a gas diffusion layer that can facilitate the diffusion of gas from the interface of the anode to a purified gas stream separated from the CO₂ stream. In this way, the anode area can oxidize one or more oxidizable species 112 to generate a protonating species.

The cathode area 151 and the anode area 152 can be separated by a separating area 155. In this disclosure, a separating area, such as 155, refers to a separating structure or region (such as a solid-state separating structure or a chemically induced separating region) that is in between the anode area and the cathode area. Specific implementations of such separating area (e.g., in the form of a separating layer and/or flush chamber to extract CO₂) will be given below in this disclosure.

In specific embodiments of the invention, the reactor, such as reactor 100 of FIG. 1, include a third output 105. The third output can be for a carbon output fluid. For example, the carbon output fluid can contain carbon dioxide generated from the anions containing carbon and the protonating species that resulted from the respective reduction and oxidation reactions. Specific embodiments of the invention benefit from the fact that the third output is separate from the anode output and the cathode output in that another output in the system can be a different, purified product free of CO₂. In specific embodiments of the invention, the third output 105 can be associated to (for example connected to) the separating area 155. In this way, an output fluid flow, such as a carbon output fluid flow, can extend through the separating area to the third output.

The carbon input fluid, such as carbon input fluid 110, and any waste products from the reduction reaction can flow through the reactor using the cathode input/output pair 101/102. The oxidizable species, such as oxidizable species 112, and any waste products from the oxidation reaction can flow through the reactor using the anode input/output pair 103/104. Furthermore, in specific embodiments of the invention, where the reactor includes a third output such as output 105, this output can be for a carbon output fluid. The third output can be separate from the anode output and the cathode output. As mentioned before and as will be apparent from the examples discussed below in this disclosure, significant benefits can accrue to these approaches in that the outputs from the reactions in the anode and cathode areas can both be free from carbon.

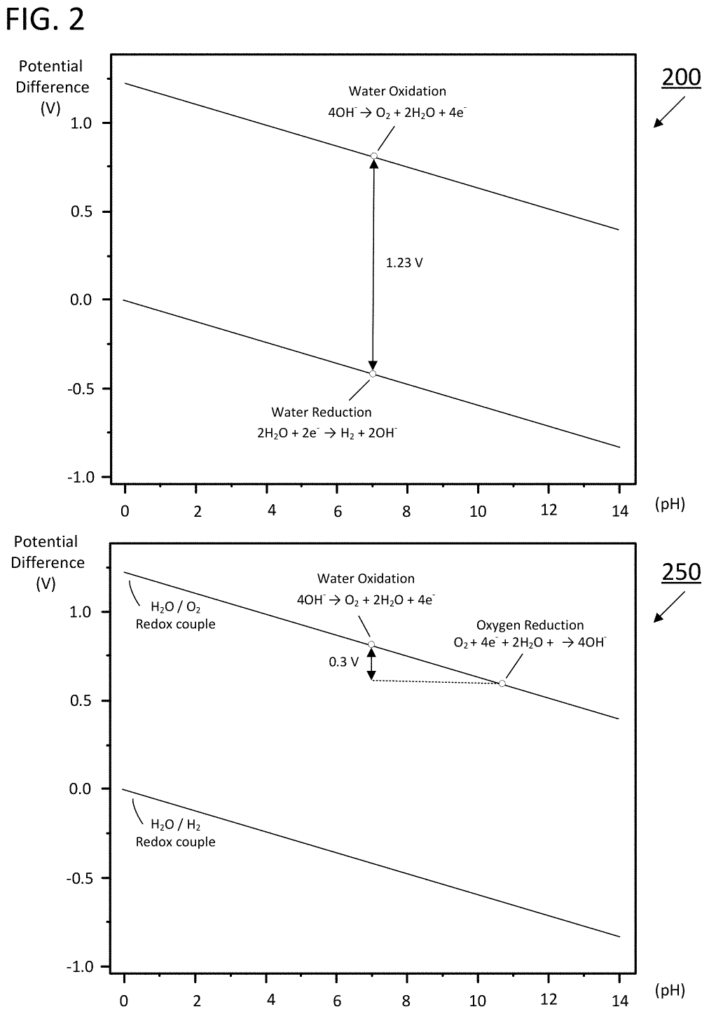

In specific embodiments of the invention, the reactor utilizes a specific electrochemical theory in which the oxidation-reduction (redox) reaction requires the application of an external voltage to the reactor of less than 1.23 V because the electrons in the redox reaction require 1.23 eV of energy. In these embodiments, the reactor will begin to produce carbon dioxide from the anions containing carbon upon the application of 1.23 V or less to the reactor as that is the voltage required to overcome the thermodynamic requirements of the redox reaction. Notably, a reactor which begins to produce carbon upon the application of 1.23 V will produce carbon at a faster rate upon increasing the voltage applied to the reactor. FIG. 2 includes graphs illustrating the energy requirements for specific redox reactions. Graph 200 illustrates the energy requirements for a standard water electrolysis reaction (in which water is separated into oxygen and hydrogen gas through the application of energy to the water). As illustrated, water oxidation and water reduction occur at a given pH level, and the potential difference required is of 1.23 V. Graph 250, on the other hand, illustrates the energy requirements for different reduction/oxidation reactions in accordance with specific embodiments of the invention. Graph 250 illustrates the behavior for an H₂O/O₂ redox couple, where the reactions are the opposite of each other. As illustrated, oxygen reduction takes place at a certain pH level while water oxidation takes place at a different pH level, in a more acidic environment. The potential difference however is only 0.3 V, which is a considerably lower voltage than what is required by the standard reaction illustrated in graph 200. In this example, the anode area pH is then lower than the cathode area pH. This difference in pH can be generated by the hydroxide generation at the cathode and proton generation at the anode as will be described below in this disclosure.

In specific embodiments of the invention, a difference in pH between the anode area and cathode area, such as the one shown in graph 250, is caused by the movement of protons out of the anode area in response to the application of voltage across the cell. This difference in pH facilitates the anions containing carbon to form on one half of the reactor and be released as CO₂ on the other. However, in specific embodiments of the invention, it can be desirable that the pH difference is as small as possible in order to maintain the required potential difference as small as possible.

In specific embodiments of the invention, the occurrence of the redox reactions in different pH levels can be possible due to the existence of a separating area between the cathode and the anode that allows reactions to occur in the cathode/anode without interfering in the outcome of the reactions taking place on the alternative side of the separating area. As mentioned before in this disclosure, the separating area can be a solid-state barrier, or a region with defined chemical properties to allow/not allow the passage of certain fluids or the occurrence of certain reactions. This separating area can allow the formation of “chambers” within the reactor. The chambers can be physical chambers such as chambers separated by a solid-state barrier or chemically separated chambers such as areas separated by a chemical phenomenon. This can allow different reactions to take place at different chambers, and therefore with different acidity levels (pH). In the illustrated example in graph 250, the oxygen reduction can take place in a different “chamber” or area than the water oxidation, with a different pH.

As illustrated in FIG. 2, the generation of a pH gradient through an electrochemical technique can require a large amount of energy. For example, in the electrolysis of water, hydroxide is generated through the reduction of water and hydroxide is consumed through the oxidation of water, as illustrated in graph 200. This can create an environment appropriate for CO₂ separation but requires large amounts of energy (minimum thermodynamic requirements of 1.23 V as illustrated in graph 200).

In the specific embodiments of the invention where the cathode and anode reactions are the reverse of each other (e.g., water oxidation at the anode and oxygen reduction at the cathode), the energy requirement are smaller, and are attributable to the difference in pH of the reaction environments (see graph 250). Alternatively, the reactions can have a small energy difference (e.g., alcohol oxidation at the anode and oxygen reduction at the cathode) while still rendering significant benefits. In particular, if the oxidation species creates a valuable byproduct that is kept separate from the captured carbon, the benefit of producing this byproduct could compensate for the additional energy required for the additional energy difference required to power the reactions. Examples of these reactions are provided below in this disclosure.

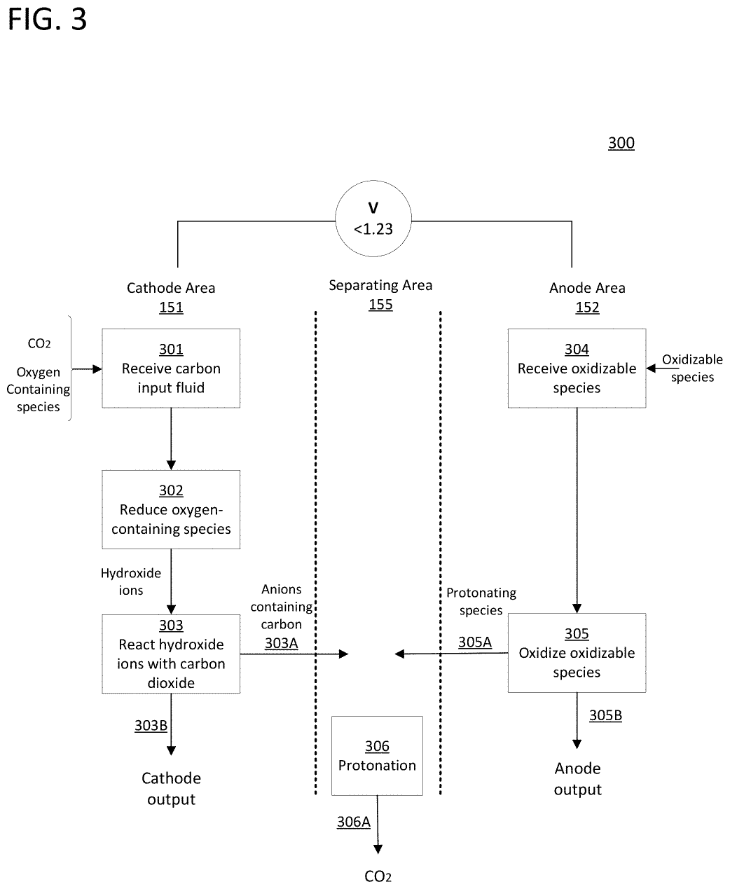

FIG. 3 includes a flowchart 300 for a set of methods for an electrolysis reactor, in accordance with specific embodiments of the invention. For ease of understanding, the steps in flowchart 300, which can all be performed by a single reactor such as reactor 100 of FIG. 1, have been distributed among a cathode area (such as cathode area 151 of FIG. 1) and an anode area (such as anode area 152 of FIG. 2). A separating area (such as separating area 155) can also be part of the reactor and certain steps can take place in such an area.

Flowchart 300 starts with a step 301 of receiving a carbon input fluid. As described before, the carbon input fluid can be received at the cathode area via a cathode input. The carbon input fluid can include CO₂ and oxygen containing species. The cathode area can perform a reduction reaction in step 302, in which the oxygen containing species can be reduced into hydroxide ions. This reaction can be Reaction 1 described before in this disclosure. The cathode area can further perform a reaction in step 303 where the hydroxide ions react with the CO₂ from the carbon input fluid to form anions containing carbon. This reaction can be Reaction 2 and/or Reaction 3 described before in this disclosure. Steps 301-303 can be conducted sequentially in the cathode area of the reactor for a given input flow. The anions containing carbon can flow from the cathode area toward the anode area in a first flow as indicated by arrow 303A. The flow of anions containing carbon from the cathode area toward the anode area can be in response to a potential (V) across a cathode terminal and an anode terminal of the reactor. In specific embodiments of the invention and as illustrated in FIG. 3, this potential can be of less than 1.23 V. Any remaining product can flow out of the reactor via a cathode output, as indicated by arrow 3036.

Flowchart 300 also includes a step 304 of receiving, at the anode area, one or more oxidizable species. This step can be conducted simultaneously with any of the steps 301-303. Flowchart 300 continues with a step 305 of oxidizing, via an oxidation reaction at the anode area, the oxidizable species to generate a protonating species. This reaction can be Reaction 6 described before in this disclosure. Steps 304 and 305 can be conducted sequentially in the anode area for a given input flow and can be conducted simultaneously with any of steps 301-303. The protonating species can flow from the anode area toward the cathode area as indicated by arrow 305A. The flow of protonating species from the cathode area in the direction of the anode area can be in response to a potential (V) across a cathode terminal and an anode terminal. In specific embodiments of the invention the protonating species will be consumed in a separating area of the reactor and will never reach the cathode area. In specific embodiments of the invention and as illustrated in FIG. 3, this potential can be of less than 1.23 V. Any remaining product can be delivered via an anode output, as indicated by arrow 305B.

In specific embodiments of the invention, and as described above, the reactor can separate CO₂ from a carbon input fluid in the form of anions containing carbon. The negatively charged anions containing carbon then flow from the cathode area towards the anode area in a first flow. The anions containing carbon can be prevented from reaching the anode area in various ways. For example, there can be a separation area as described with reference to FIG. 1, formed between the anode area and the cathode area in which the anions containing carbon are protonated. Alternatively or in combination, a fluid flow induction system can create a carbon output fluid flow and transfer the anions containing carbon from their flow towards the anode area to the carbon output fluid flow. The anions containing carbon can be protonated as they are transferred to the carbon output fluid flow. The separating area and/or output fluid flow can present a more acidic environment than the cathode area to facilitate the protonation of the anions containing carbon.

The electrolysis reactor can then produce a carbon output fluid (flow 306A), which contains CO₂ generated from the anions containing carbon (flow 303A) and the protonating species (flow 305A) in response to a potential of less than 1.23 V applied across the cathode terminal and the anode terminal. This is illustrated with step 306 in flowchart 300. This step can include Reaction 4 and/or Reaction 5 described before in this disclosure. Step 306 illustrates the protonation of the anions containing carbon generated at the cathode area by the protonating species generated at the anode area. This step can take place at a separating area between the anode and the cathode. The carbon output fluid can be provided via a third output, such as output 105 of FIG. 1, which is separate from the anode output and the cathode output. In this way, the cathode output flow (303B) and the anode output flow (305B) can be free of CO₂, while the CO₂ can be collected individually via a dedicated output.

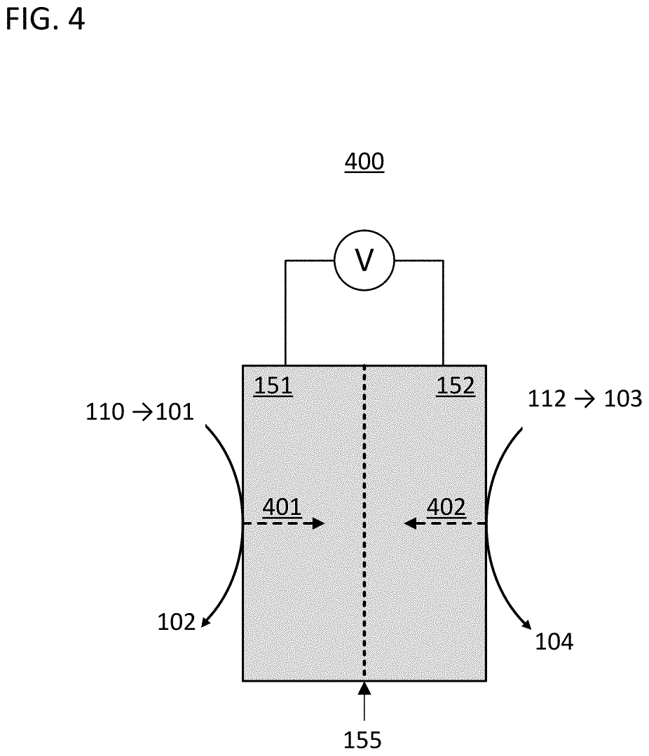

FIG. 4 includes an example 400 of a reactor with a similar structure to that described in FIG. 1 and capable of performing method 300. Same reference numbers in the two figures indicate the same or similar structure. When using a device with a static electrolyte in between two electrodes for the separation of CO₂, impure gas streams containing both CO₂ and other gases are generated. For example, if water oxidation or hydrogen oxidation is used to release CO₂ from anions containing carbon, the resulting gas stream can contain a mixture of O₂/CO₂ or CO₂/H₂ respectively. Specific embodiments of the present invention propose an electrochemical flow process that extracts CO₂ from a carbon input fluid (e.g., 110) by forming anions containing carbon such as carbonate/bicarbonate. The anions containing carbon which would be transported from the cathode to the anode by the voltage applied between the two electrodes (flow 401 in FIG. 4) can be prevented from reaching the anode using a separating area, such as separating area 155. The anodic stream (at output 104), which may contain products such as, but not limited to, O₂, H₂ or any other fluids that assist the oxidation reaction, is then advantageously free from CO₂.

The separating area can facilitate the separation and removal of separated CO₂ in various ways, as explained before with reference to flowchart 300. This separating area can facilitate the reactions mentioned above with reference to graph 250 of FIG. 2. Separating area 155 can be a solid-state layer. The separating area can provide ionic conductivity between the cathode area and the anion area. The separating area can be formed of a catalyst for the generation of CO₂ from the anions containing carbon and the protonating species.

In specific embodiments of the invention, the separating area can be a flush chamber. In those embodiments, a flowing fluid can form, or be part of, the separating area and can convert the anions containing carbon to CO₂ and/or flush out the CO₂. A fluid flow induction system can be provided that creates a carbon output fluid flow that extends through the separating area to the third output (e.g. 105). In specific embodiments of the invention, the fluid flow induction system can comprise a pump that pushes a flushing fluid through the electrolysis reactor to the third output. In specific embodiments of the invention, the fluid flow induction system can comprise a vacuum formed at the third output. The CO₂ generated from the anions containing carbon and any remaining anions containing carbon can be transferred from the first flow (e.g., 401) to the carbon output fluid flow by the fluid flow induction system.

In specific embodiments of the invention, the separating area can be a separating layer. In those embodiments, the anions containing carbon travel across the reactor towards the anode through the separating layer which can contain a medium, such as, but not limited to, an ion conducting resin or polymer. This medium may support the flow of a fluid as a means to extract CO₂ from the layer, as explained before. The medium can assist in isolating a pure stream of CO₂ by for example: providing an environment that converts anions containing carbon into CO₂; providing a medium to keep ionic conductivity across the cell whilst allowing a flushing fluid to remove CO₂; and/or providing an environment that impedes flow of anions containing carbon to the anode.

Large pH gradients between anodic and cathodic reactions lead to larger required po-tentials for separation. Efficient separation of CO₂ can then require control over the pH or ‘psuedo pH’ (attributed to a non-aqueous acid/base) exhibited by the reactor, particularly in the region designed for conversion of anions containing carbon into CO₂. The separating area of specific embodiments of the present invention can present chemical functionality to ensure the pH is below the pKa of anions containing carbon formation. These embodiments can ensure rapid protonation of the anions containing carbon to form CO₂ gas without forming a large pH drop that leads to inefficient separation. In specific embodiments, the separating area may advantageously contain functionality appropriate for the conversion of anions containing carbon to CO₂, such as, but not limited to, chemical environments similar to those present in carbonic anhydrase. In specific embodiments of the invention, the pH of the separating area is less than the pH of formation for the anions containing carbon from CO₂.

The separating area can comprise a stationary phase and/or a mobile phase that can flow through the area perpendicular to the flow of charged species. The stationary phase may consist of a cation-exchange resin which presents an environment favorable for the protonation of ionic species. In specific embodiments of the invention, the resin can have the property of presenting a ‘pseudo pH’ below that of pH 8. This can facilitate protonation of anions containing carbon to form CO₂ and water, for example through Reactions 4 and 5 described above. In specific embodiments of the invention, the stationary phase can also ensure separation and maintain ionic contact between anode and cathode.

The mobile phase can be formed by a fluid flow induction system. The mobile phase may be a flow of water, electrolyte, gas (e.g., N₂ or CO₂ or a mix), can be induced through a vacuum, and/or the like. Upon operation, anions containing carbon, generated at the cathode, can cross over an anion-exchange membrane (if present) and can be protonated in the separating layer. The mobile phase can then induce the removal of CO₂ from the reactor, which can then be collected. Protons generated at the anode can cross a cation-exchange membrane (if present) to the separating layer to replenish consumed protons.

When using a single membrane between two electrodes for the separation of CO₂, impure gas streams containing both CO₂ and other gases can be generated at the anode. For example, if water oxidation or hydrogen oxidation is used to release CO₂ from anions containing carbon, the resulting gas stream can contain a mixture of O₂/CO₂ or CO₂/H₂ respectively. In specific embodiments of the invention and as will be described below in more detail, the anions containing carbon can travel first through an anion-exchange membrane, and then to the separating layer.

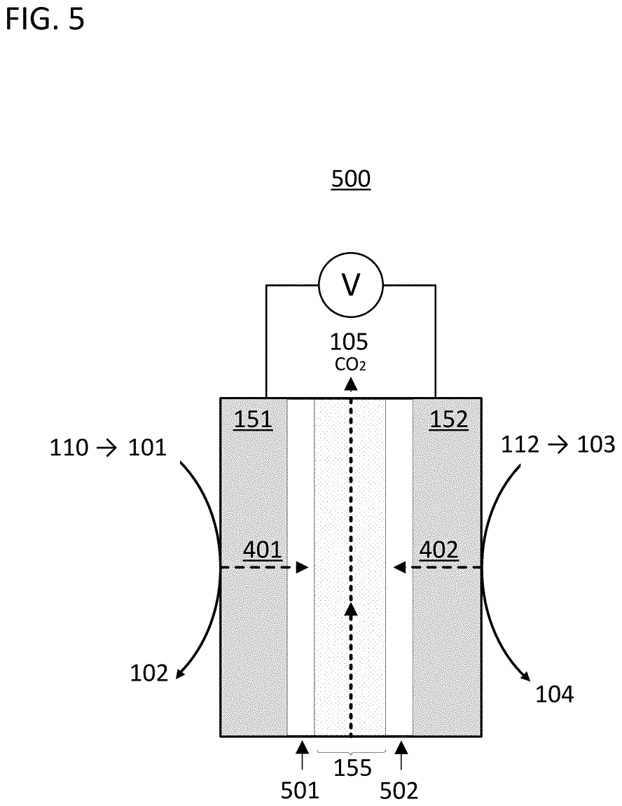

In specific embodiments of the invention, efficient physical separation of the anode area, cathode area and separating layer can allow facile separation of the gases released from each section of the reactor. Separation can occur through the use of ion-exchange membranes, which can favor the diffusion of either anions (in an anion-exchange membrane) or cations (in a cation-exchange membrane). FIG. 5 includes an example 500 of a reactor that includes an anion-exchange membrane 501, a cation-exchange membrane 502, and a separating area 155 between the two.

An anion-exchange membrane can be used between the cathode area and the separating layer. This membrane can comprise an organic polymer with positively charged functionality, such as, but not limited to, imidazolium, pyridinium or tertiary amines. This can allow facile migration of negatively charged anions containing carbon to the separating layer, where the negatively charged anions are protonated. The use of this layer can also prevent the crossover of other gases from the cathode to the separating layer. The anion-exchange membrane can be in contact with the cathode area and be permeable to the carbon containing anions, and impermeable to CO₂ and/or the protonating species.

A cation-exchange membrane can be used between the separating layer and the anode area to allow migration of protons generated at the anode to the separating layer, thereby re-plenishing protons consumed by the release of CO₂. This layer can also prevent crossover of gases/products produced at the anode from entering the separating layer. The cation-exchange membrane can be in contact with the anode area and be permeable to the protonating species and impermeable to the anions containing carbon.

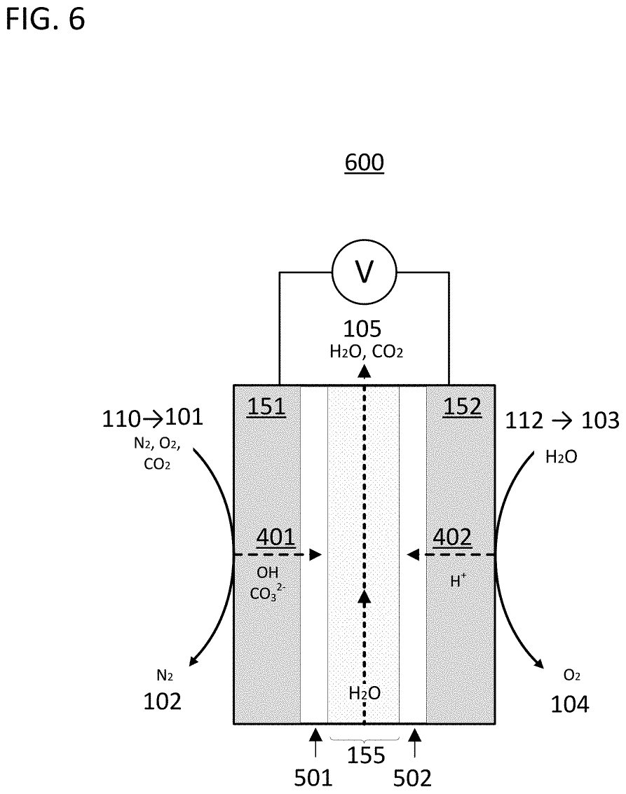

Various examples of the use of the technology described in this disclosure will be given below with reference to FIGS. 6-10. These examples are non-limiting examples and represent exemplary embodiments of the invention.

FIG. 6 includes an example 600 of a reactor used to separate CO₂ from a mixture of N₂ and O₂ (collectively the carbon input fluid 110) through the reduction of O₂, in accordance with specific embodiments of the invention. This can be of particular interest for example to capture CO₂ directly from the air. CO₂ can be captured/removed from air through the reduction of O₂ at the cathode 151 and the oxidation of water (oxidizable species 112) at the anode 152 through the process described below.

An O₂ reduction reaction, which is an example of Reaction 1 described before in this disclosure in accordance with this example is illustrated below:

O₂+2H₂O+4e⁻→4OH⁻

This reaction generates the hydroxide necessary for the capture of CO₂ at the cathode through formation of anions containing carbon (401). In this example, a carbonate formation reaction occurs and is illustrated below, which is an example of Reaction 3 described before in this disclosure. Other anions containing carbon can also be formed, such as bicarbonate formation as defined in Reaction 2 described before in this disclosure.

2CO₂+4O H⁻→2CO₃²⁻+2H₂O

The carbonate can then cross over the anion-exchange membrane 501 to the separating area 155, where the pH can be sufficiently low to convert the carbonate back into CO₂, as in Reaction 5 described before in this disclosure. An example of a CO₂ release reaction in the separating layer is illustrated below:

2CO₃²⁻+4H^{+→}2CO₂+2H₂O

The separating layer can contain a flow of water that ensures that the CO₂ produced is released from the reactor, for example via output 105. This can allow a pure stream of CO₂ to be collected, free from any other gaseous contamination. To maintain the pH in the separating layer, water oxidation can be undertaken. This can generate protons (402) that cross over the cation-exchange membrane (502) and travel to the separating area (155). This can also release the O₂ as a purified stream from the reactor at output 104. An H₂O oxidation reaction for this example is illustrated below:

H₂O→O₂+4H⁺+4e⁻

This is an example of Reaction 6 described before in this disclosure. As illustrated, this example uses reversed reduction/oxidation reactions (O₂ reduction, H₂O oxidation). The use of reversed reduction/oxidation reactions as in this example can translate into low voltage requirements for this electrolysis device as the overall voltage requirements can be based only on the pH difference between anodic and cathodic reactions (as illustrated with reference to FIG. 2) and their respective catalytic overpotentials.

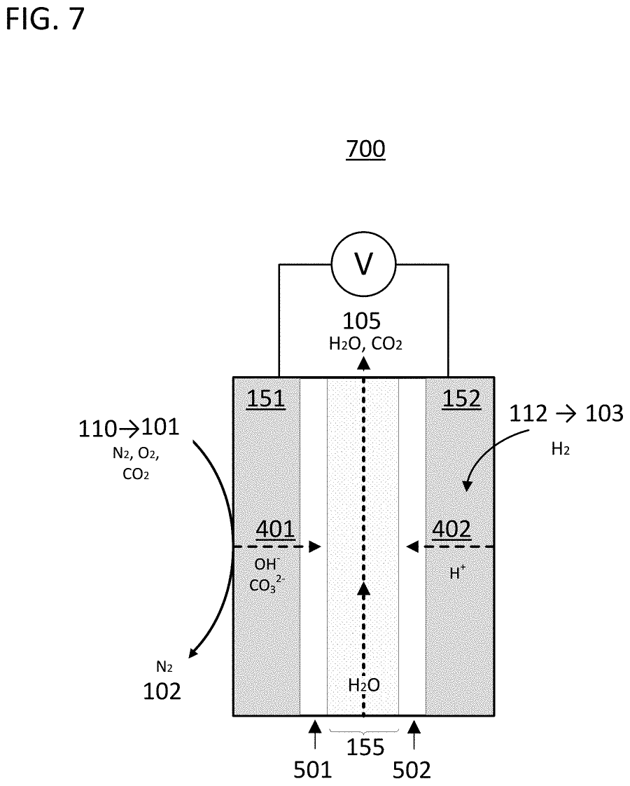

FIG. 7 includes an example 700 of a reactor where CO₂ is removed from a gas stream (carbon input fluid 110) through the reduction of O₂ at the cathode 151 and the oxidation of hydrogen, H₂, at the anode 152. In these embodiments, the cell can be said to be operating as a fuel cell as CO₂ can be captured while power is generated. CO₂ can be captured/removed from air through the reduction of O₂ at the cathode and the oxidation of H₂ at the anode through the following processes. An O₂ reduction reaction in accordance with this example is illustrated below, which is an example of Reaction 1 described before in this disclosure.

O₂+2H₂O+4e⁻→4OH⁻

As illustrated, this generates the hydroxide necessary for the capture of CO₂ at the cathode through formation of anions containing carbon (401), such as carbonate formation in this case, as an example of Reaction 3 described before in this disclosure. Bicarbonate formation may also occur as defined in Reaction 2. An example of a reaction for carbonate formation in accordance with this example is illustrated below:

2CO₂+4OH⁻→2CO₃²⁻+2H₂O

The carbonate (401) can then cross over the anion-exchange membrane (501) to the separating area (155), where the pH can be sufficiently low to convert the carbonate back into CO₂ (Reaction 5). An example of a reaction for CO₂ release in the separating layer is illustrated below:

2CO₃²⁻+4H^{+→}2CO₂+2H₂O

The separating area (155) can contain a flow of water that ensures that the CO₂ produced is released from the reactor, for example via output 105. This can allow a pure stream of CO₂ to be collected, free from any other gaseous contamination, as the CO₂ is provided via a dedicated output of the reactor, in accordance with specific embodiments of the invention.

To maintain the pH in the separating area 155, hydrogen oxidation can be undertaken. This can generate protons (402) that cross over the cation-exchange membrane (502) and travel to the separating layer (Reaction 6). An example of an H₂ oxidation reaction in accordance with this embodiment is provided below:

H₂ →2H⁺+2e⁻

The energy difference between hydrogen oxidation at the anode and oxygen reduction at the cathode can release energy during this reaction, which may be collected as electricity. This allows CO₂ to be separated in environments while generating power. These embodiments may be advantageous for undertaking other steps of CO₂ separation, such as compression. In this example, the reduction reaction is the reverse of the oxidation reaction in that the reduction reaction is the reduction of oxygen and the oxidation reaction is the oxidation of water.

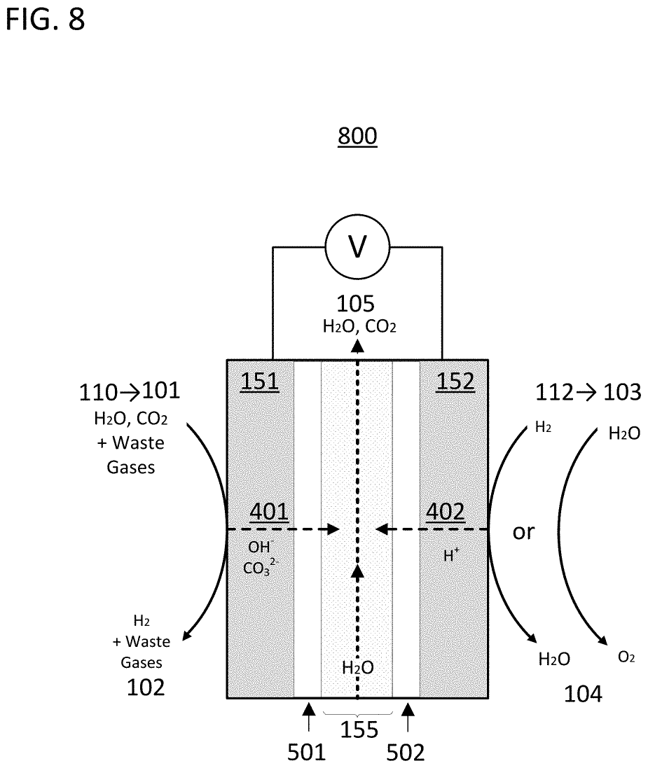

FIG. 8 includes an example 800 of a reactor where CO₂ is removed from a gas stream using water electrolysis. In this case, water and CO₂ can be introduced in the fluid 110 at the cathode. Here, water reduction can generate H₂ (output 102) and hydroxide (flow 401). An H₂O reduction reaction in accordance with this example is illustrated below:

2H₂O+2e⁻→H₂+2O H⁻

This is an example of Reaction 1 described before in this disclosure. This generates the hydroxide necessary for the capture of CO₂ at the cathode 151 through carbonate formation, as in Reaction 3 described before in this disclosure. Bicarbonate formation may also occur as defined in Reaction 2. An example of a reaction for carbonate formation is illustrated below:

2CO₂+4OH⁻→2CO₃²⁻+2H₂O

The carbonate (401) can then cross over the anion-exchange membrane (501) to the separating area (155), where the pH can be sufficiently low to convert the carbonate back into CO₂ (Reaction 5). A reaction of CO₂ release in the separating layer is illustrated below:

2CO₃²⁻+4H^{+→}2CO₂+2H₂O

The separating layer can contain a flow of water that ensures that the CO₂ produced is released from the reactor, for example via output 105. This allows a pure stream of CO₂ to be collected, free from any other gaseous contamination.

To maintain the pH in the separating layer, hydrogen oxidation or water oxidation can be undertaken (oxidizable species 112). This can generate protons (402) that cross over the cat-ion-exchange membrane (502) and travel to the separating layer (Reaction 6). Examples of H₂ oxidation and H₂O oxidation reactions in accordance with this example are illustrated below:

H₂ →O₂+4H⁺+4e⁻

H₂O→O₂+4H⁺+4e⁻

In this example, the reduction reaction is the reverse of the oxidation reaction in that the reduction reaction is the reduction of water and the oxidation reaction is the oxidation of hydrogen.

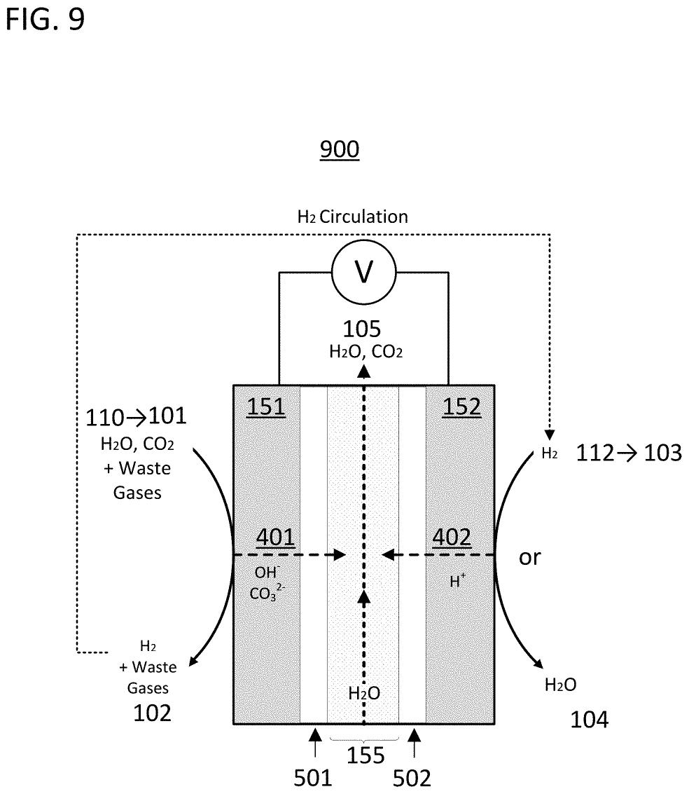

In specific embodiments of the invention, the hydrogen produced at the cathode (output 102) may be reintroduced at the anode to lower the voltage requirement of the separation, since the cathode reaction and anodic reactions are reversed. FIG. 9 illustrates an example 900 of this implementation. As illustrated, the H₂ in the cathode output 102 can circulate to the anode input 103. This embodiment can be possible via a circulator connecting the cathode area output to the anode area input. Alternatively, and as explained in example 800, water oxidation may be undertaken at a larger energetic cost, but the valuable H₂ produced at the cathode may be used elsewhere.

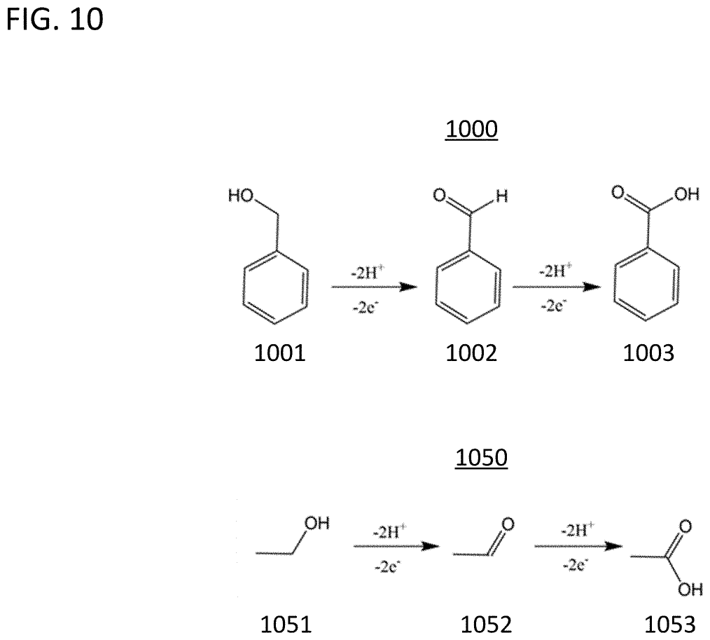

In specific embodiments of the invention, the cells presented in the previous examples may benefit from undertaking an alternate oxidation reaction to generate a valuable product during separation. Non-exhaustive examples of potential valuable oxidations are illustrated in FIG. 10. Image 1000 illustrates an example of benzyl alcohol (1001) oxidation to benzaldehyde (1002) or benzoic acid (1003). Image 1050 illustrates an example of ethanol oxidation (1051) to acetaldehyde (1052) or acetic acid (1053). In specific embodiments of the invention, the oxidizable species is an alcohol, and the oxidation reaction produces at least one of an aldehyde and a carboxylic acid. These reactions carry out the role of Reaction 6 described before in this disclosure, while producing valuable feedstocks. These embodiments can be advantageous in that they may be used to offset the costs of the CO₂ separation by the reactor.

In some circumstances, the energy costs of CO₂ separators may be substantial. At the same time the products from the anodic reaction, such as O₂ (from water oxidation) or H₂O(H₂ oxidation), may not have an intrinsic high value and the hydroxide from the reduction reaction can generally be seen as a by-product rather than the product of interest of the electrochemical process. In the embodiments such as the ones described in FIG. 10, instead of water oxidation, protons can be generated via a valuable reaction, such as oxidation of alcohols or hydrocarbons in Reaction 6. Oxidation of organic compounds may be used to produce high-added-value species and can provide the pH and protons that travel to the separating layer to convert the anions containing carbon back to CO₂ (Reaction 6). In this case, protons and electrons can be acquired from the conversion of an organic functionality to an oxidized state, as in Reaction 6, where B is the reduced form and A is the oxidized form of the organic molecule.

B→A+mH⁺+ne⁻ (6)

In those embodiments, the cost of separating CO₂ from the gas stream may then be offset by the value of the generated products, which provides a financial incentive to separate CO₂ from a gas stream or to undertake direct air capture of CO₂. In specific embodiments of the invention, the oxidizable species is an alcohol, and the oxidation reaction produces at least one of an aldehyde and a carboxylic acid.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. These and other modifications and variations to the present invention may be practiced by those skilled in the art, without departing from the scope of the present invention, which is more particularly set forth in the appended claims.

1. An electrolysis reactor comprising:
a cathode area having a cathode output and a cathode input;
an input fluid in the cathode area and supplied at the cathode input, wherein the input fluid contains carbon dioxide, and wherein the cathode area is configured (i) to reduce an oxygen-containing species from the input fluid into hydroxide ions in a reduction reaction; and (ii) to react the hydroxide ions with the carbon dioxide from the input fluid to form anions containing carbon;
an anode area;
one or more oxidizable species in the anode area, wherein the anode area is configured to oxidize the one or more oxidizable species in an oxidation reaction to generate a protonating species;
a cathode terminal;
an anode terminal;
a separating layer, between the anode area and the cathode area;
a cation-exchange membrane that allows facile migration of the protonating species from the anode area into the separating layer and is impermeable to the anions containing carbon;
an anion-exchange membrane that allows facile migration of the anions containing carbon from the cathode area into separating layer and is impermeable to the protonating species; and
wherein the electrolysis reactor is configured to begin to produce carbon dioxide from the anions containing carbon and the protonating species in response to a potential of less than 1.23 V applied across the cathode terminal and the anode terminal.

2. The electrolysis reactor of claim 1 wherein:
the reduction reaction is a reverse of the oxidation reaction.

3. The electrolysis reactor of claim 2 wherein:
the reduction reaction is the reduction of water; and
the oxidation reaction is the oxidation of hydrogen.

4. The electrolysis reactor of claim 2 wherein:
the reduction reaction is the reduction of oxygen; and
the oxidation reaction is the oxidation of water.

5. The electrolysis reactor of claim 1, further comprising:
a fluid flow induction system that creates a carbon output fluid flow for a carbon output fluid through the separating layer;
wherein the carbon output fluid contains the carbon dioxide produced from the anions containing carbon and the protonating species;
wherein the anions containing carbon flow from the cathode area toward the anode area in a first flow in response to a potential across the cathode terminal and the anode terminal; and
wherein the carbon dioxide generated from the anions containing carbon and any remaining anions containing carbon are transferred from the first flow to the carbon output fluid flow by the fluid flow induction system.

6. The electrolysis reactor of claim 1, further comprising:
a separating area formed between the cathode area and the anode area;
wherein the separating area includes the separating layer;
wherein the separating area provides ionic conductivity between the cathode area and the anode area; and
wherein the separating area is formed of a catalyst for the generation of carbon dioxide from the anions containing carbon and the protonating species.

7. The electrolysis reactor of claim 1, further comprising:
a separating area formed between the cathode area and the anode area; and
a fluid flow induction system that creates a carbon output fluid flow for a carbon output fluid through the separating layer;
wherein the separating area includes the separating layer;
wherein the carbon output fluid contains the carbon dioxide produced from the anions containing carbon and the protonating species;
wherein the separating area provides ionic conductivity between the cathode area and the anode area; and
wherein the carbon output fluid flow extends through the separating area to a third output.

8. The electrolysis reactor of claim 1, further comprising:
a separating area formed between the cathode area and the anode area;
wherein the separating area includes the separating layer;
wherein a potential is applied to the electrolysis reactor; and
wherein a pH of the separating area is less than the pH of formation for the anions containing carbon from carbon dioxide.

9. The electrolysis reactor of claim 1, wherein
the cation exchange membrane that is in contact with the anode area and is permeable to the protonating species and impermeable to the anions containing carbon.

10. An electrolysis reactor comprising:
a cathode area having a cathode output and a cathode input;
a carbon input fluid in the cathode area and supplied at the cathode input, wherein the carbon input fluid contains carbon dioxide and an oxygen-containing species,
wherein the oxygen-containing species is water, and wherein the cathode area (i) reduces the oxygen-containing species from the carbon input fluid into hydroxide ions; and (ii) reacts the hydroxide ions with the carbon dioxide from the carbon input fluid to form anions containing carbon;
an anode area having an anode input and an anode output;
one or more oxidizable species in the anode area and supplied at the anode input, wherein the anode area oxidizes the one or more oxidizable species to generate a protonating species, and wherein the one or more oxidizable species includes hydrogen gas;
a third output for a carbon output fluid, wherein the carbon output fluid contains carbon dioxide generated from the anions containing carbon and the protonating species;
wherein the third output is separate from the anode output and the cathode output;
wherein the reaction that reduces the oxygen-containing species is, water reduction;
wherein the reaction that oxidizes the oxidizable species is, hydrogen oxidation; and
the electrolysis reactor generates power.

11. The electrolysis reactor of claim 10, further comprising:
a cathode terminal;
an anode terminal; and
a fluid flow induction system that creates a carbon output fluid flow for the carbon output fluid;
wherein the anions containing carbon flow from the cathode area toward the anode area in a first flow in response to a potential across the cathode terminal and the anode terminal; and
wherein the carbon dioxide generated from the anions containing carbon and any remaining anions containing carbon are transferred from the first flow to the carbon output fluid flow by the fluid flow induction system.

12. The electrolysis reactor of claim 11, wherein:
the fluid flow induction system comprises a vacuum formed at the third output.

13. The electrolysis reactor of claim 11, wherein:
the fluid flow induction system comprises a pump that pushes a flushing fluid through the electrolysis reactor to the third output.

14. The electrolysis reactor of claim 10, further comprising:
a separating area formed between the cathode area and the anode area;
wherein the separating area provides ionic conductivity between the cathode area and the anode area; and
wherein the separating area is formed of a catalyst for the generation of carbon dioxide from the anions containing carbon and the protonating species.

15. The electrolysis reactor of claim 10, further comprising:
a separating area formed between the cathode area and the anode area; and
a fluid flow induction system that creates a carbon output fluid flow for the carbon output fluid;
wherein the separating area provides ionic conductivity between the cathode area and the anode area; and
wherein the carbon output fluid flow extends through the separating area to the third output.

16. The electrolysis reactor of claim 10, further comprising:
a separating area formed between the cathode area and the anode area; and
wherein a pH of the separating area is less than a pH of formation for the anions containing carbon from carbon dioxide.

17. The electrolysis reactor of claim 10, further comprising:
a cation-exchange membrane that is in contact with the anode area, is permeable to the protonating species, and is impermeable to the anions containing carbon.

18. The electrolysis reactor of claim 10, further comprising:
a cathode terminal; and
an anode terminal;
wherein the electrolysis reactor begins to produce carbon dioxide from the anions containing carbon and the protonating species in response to a potential of less than 1.23 V applied across the cathode terminal and the anode terminal.

19. The electrolysis reactor of claim 18, wherein:
the cathode area reduces the oxygen-containing species in a reduction reaction;
the anode area oxidizes the one or more oxidizable species in an oxidation reaction; and
the reduction reaction is a reverse of the oxidation reaction.

20. (canceled)

21. (canceled)

22. (canceled)

23. (canceled)

24. The electrolysis reactor of claim 10 further comprising:
a circulator connecting the cathode output to the anode input;
wherein hydrogen gas is supplied to the anode input from the cathode output by the circulator.

25. A method comprising:
receiving, at a cathode area of an electrolysis reactor, an input fluid containing carbon dioxide, wherein the cathode area comprises a cathode terminal and a cathode input for the input fluid and a cathode output;
reducing, via a reduction reaction at the cathode area, an oxygen-containing species from the input fluid into hydroxide ions;
reacting, at the cathode area, the hydroxide ions with the carbon dioxide from the input fluid to form anions containing carbon;
oxidizing, via an oxidation reaction at an anode area of the electrolysis reactor having an anode terminal, an anode input and an anode output, one or more oxidizable species to generate a protonating species;
providing, at a third output, a carbon output fluid, wherein the carbon output fluid contains carbon dioxide generated from the anions containing carbon and the protonating species;
providing, a separating layer between the anode area and the cathode area; and
allowing facile migration of the protonating species from the anode area into the separating layer using a cation-exchange membrane that is impermeable to the anions containing carbon;
allowing facile migration of the anions containing carbon from the cathode area into the separating layer using an anion-exchange membrane that is impermeable to the protonating species;
wherein the third output is separate from the anode output and the cathode output; and
wherein the generating of the carbon output fluid from the anions containing carbon and the protonating species begins in response to a potential of less than 1.23 V applied across the cathode terminal and the anode terminal.

26. The method of claim 25, wherein:
the reduction reaction is a reverse of the oxidation reaction.

27. The method of claim 25, wherein:
the reduction reaction is the reduction of water; and
the oxidation reaction is the oxidation of hydrogen.

28. The method of claim 25 wherein:
the reduction reaction is the reduction of oxygen; and
the oxidation reaction is the oxidation of water.

29. The method of claim 25, wherein:
the electrolysis reactor begins to produce carbon dioxide from the anions containing carbon and the protonating species in response to a potential of less than 1.23 V applied across a cathode terminal and an anode terminal.

30. The method of claim 25, further comprising:
creating, via a fluid flow induction system of the electrolysis reactor, a carbon output fluid flow for the carbon output fluid;
wherein the anions containing carbon flow from the cathode area toward the anode area in a first flow in response to a potential across a cathode terminal and an anode terminal; and
wherein the carbon dioxide generated from the anions containing carbon and any remaining anions containing carbon are transferred from the first flow to the carbon output fluid flow by the fluid flow induction system.
